(19) United States
(12) Patent Application Publication
(10) Pub. No.: US 2025/0305253 A1
(43) Pub. Date: Oct. 2, 2025

(54) RETAINER SYSTEMS

(71) Applicant: 2MT Mining Products Pty Ltd, Queensland (AU)

(72) Inventor: Mahinda Palitha SENANAYAKE, Queensland (AU)

(21) Appl. No.: 18/864,304

(22) PCT Filed: Mar. 28, 2023
(86) PCT No.: PCT/AU2023/050226

§ 371 Date: Nov. 8, 2024

(30) Foreign Application Priority Data
May 11, 2022 (AU) 2022901257
Jan. 24, 2023 (AU) 2023900162

(51) Int. Cl. E02F 9/28

(52) U.S. Cl. CPC E02F 9/2833; E02F 9/2825; E02F 9/2883

(57) ABSTRACT

A wear protection system for earthmoving/mining equipment including a mount for securement to a part of the equipment to be protected, a wear part releasably mounted to the mount, and a retainer to retain the wear part to the mount. The mount includes a recess and the wear part includes a wall with a passage, which is positioned to align with the mount recess. A threaded coil is mounted in the wear part to extend substantially around the passage. The retainer includes a pin/bolt having a head with a threaded shank which extends distally to a free end. The parts are configured and arranged so that the shank of the pin/bolt can be pushed into the passage in the wear part to engage with the recess in the mount to secure the wear part to the mount and be retained by engagement of the threaded coil with the threaded shank.

This invention relates to retainer systems for wear parts and rigging components for earthmoving and mining equipment. The invention has particular application to wear parts for excavator buckets and dragline buckets and the invention will be described with particular reference to such application. However, the invention may also have application to wear parts for other types of equipment, for example, shovel buckets, bucket loaders, bulldozer blades, drotts, bobcats, backhoes and others.

The invention may also have application to retainer systems for load bearing pins such as trunnion pins, anchor pins and the like, especially pins which are subject to significant wear and have to be replaced relatively often but it may also have application to other types of wear parts or pins which have to be reliably secured or locked in a working position.

In this specification, the term “wear parts” generally includes teeth and adaptors for mounting the teeth to the nose mounts, nose mounts, lips and lip shrouds, lip end protectors, wing shrouds, heel shrouds, drag hitch protectors, anchor brackets and pins, drag pins and socket brackets, trunnion brackets and pins and similar wear parts. However, the invention will be described with particular reference to teeth and adaptors.

Typically, excavator buckets, dragline buckets and the like have a base or floor with a cutting edge (or lip) to which ground engaging tools such as teeth and adaptors are fitted to engage the ground or spoil which is to be excavated. The ground engaging tools which are generally subject to the greatest wear are the teeth and a number of parts or components are associated with the teeth. The first component, often called the nose or nose mount, is usually fixed in a permanent or semi-permanent manner to the lip by welding, and protrudes forward from the lip. The second component is releasably mounted on or to the nose so that it can be replaced when it reaches a predetermined wear condition. In some types of equipment the second component is the cutting tip, tooth, or tooth point, which engages the ground at its front edge and suffers the main wear while in other equipment, the second component is an adaptor to which a third component being the cutting tip or tooth is releasably fitted which in turn suffers the main wear while the adaptor suffers lesser wear.

Thus, it will be understood that while the teeth in a three component system will have a much shorter life than the adaptors, the adaptors themselves do eventually wear out and have to be replaced. Even the nose may wear out long before the bucket floor and walls and will have to be replaced but in the case of the noses, they can be cut away from the base or lip and be replaced by new noses which can be welded to the base, although that requires substantial downtime for a fairly substantial operation. In the case of a two component system, while the releasable teeth can be replaced relatively easily, if the noses wear out, a fairly substantial operation is required to replace them as with a three component system.

Further, the portions of the lip between the spaced apart noses also dig to some extent and are exposed to the abrasive effects of spoil flowing across the upper face thereof and at the same time the lower face suffers the abrasive effects of sliding across the ground. While the lip itself may be a semipermanent wear plate welded or bolted to the bucket floor, replacement from time to time can require a substantial time consuming operation. Consequently, in order to extend the life of a lip or lip plate, lip shrouds are often fitted between the nose mounts and secured to the lip or the floor by a retainer system which allows them to be removed and replaced as required.

In some buckets, the lip extends sideways beyond the side walls of the bucket and the ends of the lip outside the bucket are subject to abrasion by spoil flowing past the end of the lip or by the end of the lip moving relative to the material being mined or excavated. The lip ends are typically covered by lip end protectors which are fitted thereto so as to protect the lip ends themselves from wear by the spoil flowing past in much the same manner as the lip shrouds protect the lip from spoil flowing between the teeth and the adapters.

In some buckets, especially dragline buckets, the front vertical (or inclined) edges of the side walls are typically covered by replaceable wear parts often referred to as wing shrouds.

Thus, it will be appreciated that where possible, those parts or portions of a bucket which are most subject to wear are protected by components which can be more easily and cost effectively replaced as they wear rather than replacing the more permanent parts of the bucket.

The present invention is aimed at providing wear parts and retainer systems for securing the wear parts to the relevant parts of the bucket which for ease of reference may be referred to in the specification as “mother part” or “mother component” or “mother material” or some similar term. It will be appreciated that in some cases, one wear part may become a mother component when viewed from the perspective of another wear part. For example, a tooth might be mounted on a nose portion of an adaptor which in turn might be mounted to a nose mount welded to a lip. Thus, while the adaptor itself is a wear part, from the perspective of the tooth it might be a mother part or a mother component.

While teeth, adapters, lip shrouds, lip end protectors and the like are subject to more wear than other components and consequently will likely benefit from the present invention more than other wear parts, there are other wear parts which do require replacement throughout the life of the bucket, for example, drag hitch protectors, anchor brackets and pins, drag pins and socket brackets, trunnion brackets and pins, and such components will also likely benefit from the present invention. Some such components may not be commonly referred to as wear parts in mining and earthmoving practice, but in this specification, such components are considered to be “wear parts”.

One of the difficulties with retainer systems for retaining replaceable wear parts on a mother part is that the retainer systems are subject to incursion of “fines” from the spoil, that is, very small particles of spoil. Where threaded fasteners such as bolts and nuts have been used to secure the wear part to a mother part, the fines work their way into the threads and cause the bolts or nuts to seize which makes removal difficult, for example, removing a tooth or adaptor from a nose mount welded to a lip or a tooth from an adaptor nose portion.

There have been many attempts to overcome the problem of fines, for example, U.S. patent application Ser. No. 12/724,322 (published as US2010/0170119) teaches the use of a locking pin with a radially extending lug which is arranged to engage with a washer-like member more or less in the manner of a bayonet fitting with the washer being formed of a resilient material with a seat for the lug, the resilient material being adapted to apply an axial force to the lug to hold it in the seat. One of the problems with that system is that the washer itself being formed of a resilient material, wears and then lets in fines and the locking pin becomes loose or seizes.

Another device used generally for the same purpose of securing a wear part to a mother part is shown in U.S. Pat. No. 6,959,506 to Adamic which incorporates a threaded insert which is fitted to a recess in the side wall of a tooth from the inside and a threaded pin which is then screwed into the insert from the outside and extends into an aligned passage in the nose. Again, fines get into the thread and cause the pin to seize making removal difficult or fines work their way between the threaded insert and the tooth causing the insert to become loose which in turn makes removal of the threaded pin difficult.

The present invention is aimed at providing a retainer system which overcomes or at least ameliorates one or more of the problems of the presently available systems. The present invention is also aimed at providing wear parts which are adapted to cooperate with the retainer system although in some cases, the present retainer system may be adapted for use with some known wear parts.

The present invention in one form provides a securing (or retainer) system in which one component secures the wear part to the mother part and is to some extent self-locking in the securing position. The invention also provides wear parts (such as teeth and adaptors) which incorporate features intended for use with a retainer system according to the present invention. The invention also provides components of a retainer or locking system according to the invention.

In this specification, unless the context clearly requires a different meaning, the term forward and its derivatives are to be understood as being in the direction of movement of the lip or bucket when digging or filling the bucket with spoil. Terms such as upper, lower, side, front, rear, and the like are to be understood in the context of the bucket moving forward so that the leading edge of the lip or the teeth is the front. Similarly, the term horizontal is to be understood as approximately the orientation relative to the bottom of an excavator bucket when resting on the ground and vertical is a direction generally upstanding from horizontal although it may be used to refer to a wall or component which is not “vertical” in a purely geometric sense. Such terms are used herein to assist in describing the invention and are not intended to limit the invention to use in any particular orientation.

With the foregoing in view the invention in one aspect resides broadly in a wear protection system for earthmoving and mining equipment including:
a mount adapted to be secured to a mother part of the equipment;
a wear part adapted to be releasably mounted on or to said mount; and
a retainer adapted to retain or secure said wear part on or to said mount;
wherein said mount includes a passage or recess therein; and
wherein said wear part includes a wall portion having a passage therethrough, said passage being positioned to generally align with said passage or recess in said mount and wherein a spiral coil is mounted in said wall portion of said wear part to form a thread extending substantially around said passage or in said mount to form a thread extending substantially around said passage or recess therein; and
wherein said retainer includes a pin or bolt, said pin or bolt having a free end and at least a portion tapering inwards towards said free end, and a spiral groove or thread on or in at least a portion of said pin or bolt;
said parts being so made and arranged that said pin or bolt can be pushed into said passage in said wall portion of said wear part to engage with said passage or recess in said mount so as to secure said wear part to said mount and be retained by engagement of said spiral coil with said spiral groove or thread.

In another aspect the invention resides broadly in a method of fitting a wear protection system to earthmoving or mining equipment, the method including:
providing a mount adapted to be secured to a mother part of the equipment, said mount including a passage or recess therein;
providing a wear part adapted to be releasably mounted on or to said mount, said wear part including a wall portion having a passage therethrough and a spiral coil mounted in said wall portion of said wear part and forming a thread extending substantially around said passage; and
providing a retainer adapted to retain or secure said wear part on or to said mount, said retainer including a pin or bolt having a free end and at least a portion tapering inwards towards said free end and a spiral groove or thread on or in at least a portion of said pin or bolt;
fitting said wear part to said mount such that said passage in said wall portion generally aligns with said passage or recess in said mount;
pushing said pin or bolt into said passage in said wear part to engage in said passage or recess in said mount and with said spiral coil engaging said spiral groove or thread to secure said wear part to said mount.

In another aspect the invention resides broadly in a method of fitting a wear protection system to earthmoving or mining equipment, the method including:
providing a mount adapted to be secured to a mother part of the equipment, said mount including a passage or recess therein and a spiral coil mounted in said mount to form a thread extending substantially around said passage or recess therein;
providing a wear part adapted to be releasably mounted on or to said mount, said wear part including a wall portion having a passage therethrough;
providing a retainer adapted to retain or secure said wear part on or to said mount, said retainer having a free end and at least a portion tapering inwards towards said free end and a spiral groove or thread on or in at least a portion of said pin or bolt;
fitting said wear part to said mount such that said passage in said wall portion generally aligns with said passage or recess in said mount; and
pushing a pin or bolt into said passage in said wear part to engage in said passage or recess in said mount such that said spiral coil engages with said spiral groove or thread on or in said pin or bolt to secure said wear part to said mount.

Suitably, the pin or bolt is pushed into the passage from outside the wear part irrespective of whether the spiral coil is mounted in the wear part or in the mount.

The term “substantially around said passage or recess is intended to encompass cases where the spiral coil encroaches on the passage, that is, where the coil is partly in the wall portion and partly in the passage as will be appreciated from the accompanying drawings.

Preferably, the parts are so made and arranged that said pin or bolt can be rotated to screw and/or unscrew along said spiral groove or thread to further engage and/or disengage said pin or bolt to release said wear part from said mount. For that purpose, the pin or bolt may include means for fitting a tool thereto. In one preferred form, the pin or bolt has a recess adapted to accept an Allen key or hex key therein.

It is also preferred that the pin or bolt have a head and a shank wherein the shank tapers inwards away from the head over at least a portion of its length. In such form of the invention it is preferred that the shank have a non-tapered portion adjacent the head (that is substantially cylindrical) and that the tapered portion be contiguous with the non-tapered portion and extends to the free end.

In some embodiments of the invention it may be necessary or desirable to finalise the position of the pin or bolt after the pushing action by screwing the pin or bolt further into engagement with the spiral coil. For example, the screwing action may be required to lock the pin in a more secure locked position.

In another aspect, the invention resides broadly in a wear part for use with a wear protection system for earthmoving and mining equipment, the wear part including:
a wall portion having a passage therethrough adapted to receive a pin or bolt therein, and a spiral coil mounted in said wall portion and adapted form a thread extending substantially around said passage.

In another aspect, the invention resides broadly in a mount for use with a wear protection system for earthmoving and mining equipment according to the present invention, the mount including a passage or recess therein and a spiral coil mounted in said mount to form a thread extending substantially around said passage or recess.

Preferably, said spiral coil extends less than one full turn about said passage or recess in the wear part or the mount as the case may be whereby the opposite ends of the coil are allowed to abut a stopper portion of the wear part or the mount and configured to prevent the coil from rotating relative to the wall portion. For example, the stopper portion may be a lug or other protuberance of the wear part or the mount which extends into the passage or recess.

Preferably, the spiral coil is a coil of a compression spring. In such form it is preferred that the spring wire diameter and type be selected to suit the size and loading of the wear part and the diameter of the pin or bolt.

In yet another aspect, the invention resides broadly in a retainer pin or bolt for use with a wear protection system for earthmoving and mining equipment, the retainer pin or bolt including:
a head and a shank extending from said head, said shank tapering inwards away from said head over at least a portion of said shank, and
a spiral groove or thread on or in at least a portion of said shank.

In still another aspect, the invention resides broadly in a retainer pin for use with a wear protection system for earthmoving and mining equipment, the retainer pin having a free end and tapers towards the free end over a portion of its length, and a spiral groove or thread on or in at least a substantial portion of said tapered portion.

In such form of the invention it is preferred that the spiral groove or thread has a plurality of turns of the same radius and that the spiral groove or thread be arranged such that it gradually runs out on the tapered portion at a predetermined distance from the free end. In such form, the predetermined distance is selected to ensure that a sufficient portion of the pin may enter the spiral coil before the coil is engaged by the groove to assist with alignment of the pin in the coil.

Preferably, the portion of the shank which is intended to locate in a wall portion of the wear part is generally cylindrical, that is, not tapered, and in such form of the invention, the tapered portion of the pin extends from the inner face of the wall portion of the wear part to the free end of the pin or bolt. It is also preferred that the taper of the pin be in the range of 1.5 to 5.5 degrees and more preferably 2.0 to 4.0 degrees and most preferably about 2.0 degrees to the longitudinal axis of the pin. In other words, the included angle of the tapered portion is preferably in the range of 3.0 to 7.0 degrees and more preferably in the range of 4.0 to 8.0 degrees and most preferably about 4.0 degrees. In the case of a headless pin the same features are also preferred.

Preferably said passage through the wall portion of the wear part opens outwardly to a recess adapted to accommodate the head of the pin or bolt therein (in cases where the pin has a head). In such form it is preferred that the recess terminate in a shoulder face adjacent the passage against which the head of the bolt or pin may rest. It is also preferred that such a shoulder have a recess therein in which a detent may engage to prevent the pin or bolt unintentionally unscrewing.

Preferably the head of the pin or bolt and the wear part have inter-engaging locking means adapted to inhibit unscrewing of the pin or bolt. In a preferred form the inter-engaging locking means includes a detent such as a tang or the like extending radially from the head and adapted to engage with complementary locating means in the aforementioned shoulder recess of the wear part. In a preferred form, the detent is adapted to engage in a recess provided in the face of the shoulder face of the recess. It will be appreciated that the detent and the recess could be reversed. However, in a slightly different form of the invention, the head of the pin or bolt has a face adapted to engage the shoulder face of the head recess and a detent extends from that face (in an axial direction) and is configured to engage in a recess provided in the shoulder face defining the inner end of the recess.

Preferably, the pitch of the grooves in the pin or bolt is selected to match the pitch of the spiral coil in the wear part. However, it is also preferred that the groove adjacent the head of the pin or bolt be widened (in the axial direction) over a portion of the groove in the region of the locking means when locked thereby allowing the portion of the coil in that region to move within the widened groove to allow the detent to move out of the recess as the pin is unscrewed or to jump over a locking lug or the like where such type of locking mechanism is used.

It will be appreciated that the widening of the groove in that region effectively decreases the pitch of that groove over an arc of the spiral groove. In such form of the invention, it is preferred that the change of pitch have a steady lead-in portion designed to suit the spring wire selected for the spiral coil.

Preferably, the head of the pin or bolt has means for connection of a tool for unscrewing the pin or bolt, for example a hex head, a hex key or Allen key head or the like.

In another aspect, the invention resides broadly in a wear protection system for earthmoving and mining equipment including:
a first component, a second component, and a third component, wherein the third component is a helical coil adapted to be fitted to a passage or recess provided in one of said first and second components to form a thread therein and wherein said one component includes means for preventing or at least inhibiting unwanted rotation of said third component relative thereto.

In one such form, the invention includes a fourth component, the fourth component being a pin or bolt or the like adapted to be pushed through the helical coil in the first or second component and engage in the other one of the first and second components, the pin or bolt (or the like) have a spiral groove along at least a portion of its length and adapted to at least partially receive therein the helical coil along its length.

In one form of the invention, the first component is a mount adapted to be secured to a part of the equipment to be protected and the second component is a wear part adapted to be releasably mounted on or to said mount. In one such preferred form the third component is fitted to the wear part. However, in another form, the third component is fitted to the mount. In some arrangements embodying the invention, a plurality of such wear protection systems may be used to retain or secure a wear part to a mount.

In yet another aspect, the invention resides broadly in a nose mount, tooth and retainer in combination for earthmoving or mining equipment;
the nose mount having a base for securing the nose mount to the lip of a bucket and a protuberance extending forwardly therefrom with one or more recesses or passages provided therein;
the tooth having a cutting tip at its front and a mounting portion rearward of the cutting tip, the mounting portion including one or more walls defining a cavity therein opening to the rear and adapted to at least partially receive therein the protuberance of the nose mount, a passage through at least one of said one or more walls, said passage being positioned to generally align with one of said one or more recesses or passages in said protuberance and a spiral coil mounted in said passage to form a thread extending substantially around said passage;
the retainer including a pin or bolt, said pin or bolt having a head and a shank extending from said head, said shank tapering inwards away from said head over at least a portion of said shank and terminating in a free end, and a spiral groove or thread on or in at least a portion of said shank;
the parts being so made and arranged that the shank of said pin or bolt can be pushed into said passage in said wall from outside said tooth to engage with said passage or recess in said nose mount to secure said wear part to said mount and be retained by engagement of said spiral coil with said spiral groove or thread.

In still yet another aspect, the invention resides broadly in an adaptor, nose mount and retainer in combination for earthmoving or mining equipment;
the nose mount having a base for securing the nose mount to the lip of a bucket and a protuberance extending forwardly therefrom with one or more recesses or passages provided therein;
the adaptor having a mounting portion including one or more walls defining a cavity therein opening to the rear and adapted to at least partially receive therein the protuberance of the nose mount, and a passage through at least one of said one or more walls, said passage being positioned to generally align with one of said one or more recesses or passages in said protuberance of said nose mount and a spiral coil mounted in said passage to form a thread extending substantially around said passage, the adaptor also having a protuberance extending forwardly from said mounting portion and adapted to receive thereon a tooth;
the retainer including a pin or bolt, said pin or bolt having a head and a shank extending from said head, said shank tapering inwards away from said head over at least a portion of said shank and terminating in a free end, and a spiral groove or thread on or in at least a portion of said shank;
wherein said parts are so made and arranged that the shank of said pin or bolt can be pushed into said passage in said wall of said adaptor to engage with said passage or recess in said nose mount to secure said adaptor to said mount and be retained by engagement of said spiral coil with said spiral groove or thread.

Preferably, the adaptor has a protuberance extending forwardly from the mounting portion with one or more recesses or passages provided therein and adapted to receive thereon a tooth.

In still yet another aspect, the invention resides broadly in an adaptor, tooth and retainer in combination for earthmoving or mining equipment;
the adaptor having a mounting portion including one or more walls defining a cavity therein opening to the rear and adapted to at least partially receive therein the protuberance of a nose mount, and a protuberance extending forwardly therefrom with one or more recesses or passages provided therein;
the tooth having a cutting tip at its front and a mounting portion rearward of the cutting tip, the mounting portion including one or more walls defining a cavity therein opening to the rear and adapted to at least partially receive therein the protuberance of the adaptor, a passage through at least one of said one or more walls, said passage being positioned to generally align with one of said one or more recesses or passages in said protuberance of said adaptor and a spiral coil mounted in said passage to form a thread extending substantially around said passage;
the retainer including a pin or bolt, said pin or bolt having a head and a shank extending from said head, said shank tapering inwards away from said head over at least a portion of said shank and terminating in a free end, and a spiral groove or thread on or in at least a portion of said shank;
the parts being so made and arranged that the shank of said pin or bolt can be pushed into said passage in said wall of said tooth to engage with said passage or recess in said protuberance to secure said tooth to said adaptor and be retained by engagement of said spiral coil with said spiral groove or thread.

Preferably, said parts are so made and arranged that said pin or bolt can be rotated to screw and/or unscrew along said spiral groove or thread to disengage said pin or bolt from said mount or protuberance to release said tooth from said mount or protuberance as the case may be.

Preferably, said spiral coil extends less than one full turn about said passage whereby the opposite ends of the coil are allowed to abut a stopper portion of the wall portion configured to prevent the coil from rotating relative to the wall portion.

Preferably, said spiral coil is a compression spring coil. In such form it is preferred that the spring wire diameter and type be selected to suit the size and loading of the wear part and the diameter of the pin or bolt.

In another aspect, the invention resides broadly in a wear part for use with a wear protection system for earthmoving and mining equipment, the wear part including:
a wall portion having a passage therethrough adapted to receive a pin or bolt therein, and a recess extending substantially about the passage, the recess being adapted to hold therein a part coil of an extension spring adapted to form a thread about the passage and stop means at the ends of the recess or in the recess adapted to engage the opposite ends or end portions of a coil in the recess.

Preferably, the recess extends through an arc in the range of about 320 degrees to about 350 degrees, more preferably about 330 degrees to 340 degrees and most preferably about 335 degrees and terminates at each end at a face extending radially outwards. In such form, the face constitutes the stop means and the end faces of the spiral coil are substantially perpendicular to the spiral axis of the coil wire.

In yet another aspect, the invention resides broadly in a spiral compression spring coil of less than one full turn and extending through an arc of between 320 degrees and 350 degrees. Preferably, the spiral coil extends through an arc of between 330 degrees and 340 degrees. More preferably, the spiral coil extends through an arc of about 335 degrees. Preferably, the ends of the spiral coil are substantially perpendicular to the spiral axis of the spring wire. It is also preferred that the diameter of the coil wire be about one tenth of the diameter of the coil and the pitch of the spring coil be slightly greater than the diameter of the wire.

In still yet another aspect, the invention resides broadly in a retainer component including:
a housing adapted to be mounted in a complementary recess in a wear part, for example a tooth, the housing having a passage adapted to receive a locking pin therethrough; and
a spiral coil mounted in said housing and arranged to form at least a part thread therein substantially around said passage for engagement by a complementary locking pin.

Preferably the housing includes first stop means adapted to engage the opposite ends or end portions of the spiral coil to substantially prevent or inhibit rotation thereof relative to the housing.

Preferably the housing defines a recess therein extending substantially about said passage and said spring coil is mounted in said housing such that it extends about said channel and encroaches on said passage around its periphery so that it can be threadedly engaged by said pin.

Preferably, the housing incudes second stop means adapted to engage with complementary second stop means on or in the wear part in which the component is to be mounted for preventing rotation of the housing relative to the wear part.

In still yet another aspect, the invention resides broadly in a housing for a spiral coil, including:
a passage adapted to receive a locking pin therethrough and a recess extending substantially around said passage;
first stop means extending into said recess for engaging the opposite ends or end portions of a spiral coil adapted to be mounted in said recess to substantially prevent or inhibit rotation thereof relative to the housing; and
second stop means adapted to engage with complementary second stop means on or in a wear part in which the housing is to be mounted for preventing rotation of the housing relative to the wear part.

In still yet another aspect, the invention resides broadly in a retainer component including:
a housing having a passage adapted to receive a locking pin therethrough and a recess extending substantially around said passage;
first stop means extending into said recess for engaging the opposite ends or end portions of a spiral coil adapted to be mounted in said recess to substantially prevent or inhibit rotation thereof relative to the housing;
second stop means adapted to engage with complementary second stop means on or in a wear part in which the housing is to be mounted for preventing rotation of the housing relative to the wear part; and
a spiral coil mounted in said housing and extending substantially around said passage.

Preferably, the recess extends through an arc in the range of about 320 degrees to about 350 degrees, more preferably about 330 degrees to 340 degrees and most preferably about 335 degrees and terminates at each end at a face extending radially outwards. In such form, the face constitutes the stop means and the end faces of the spiral coil are substantially perpendicular to the spiral axis of the coil wire.

It will be appreciated that where the specification refers to a spiral coil mounted in a passage through a wall of a wear part, such as a tooth or an adapter or another wear part, the spiral coil may be mounted in a housing which in turn is mounted in a recess or passage through a wall of the wear part.

In that respect, the passage may have a narrow portion adapted to slidably receive the pin or bolt and a larger portion adapted to receive therein a housing in which the spiral coil is mounted. The same applies to a mount mutandis mutatis in that the passage or recess in the mount may have a larger portion adapted to receive therein a housing in which the spiral coil is mounted. In such cases where reference is made to a spiral coil mounted in a passage and extending substantially around a passage, the passage about which the spiral coil extends is the passage through the housing. Thus, effectively the housing becomes a part of the wear part or the mount and the spiral coil extends substantially around the passage through the housing.

In order that the invention may be more easily understood and put into practical effect, reference will now be made to the accompanying drawings wherein:

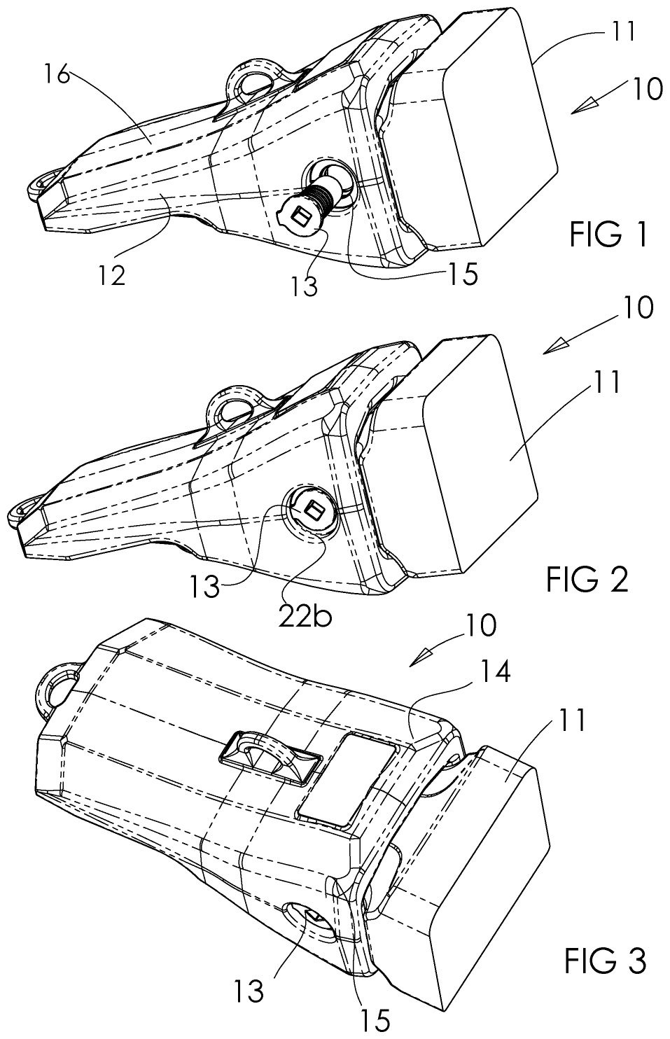

FIG. 1 is a pictorial representation of an excavator bucket tooth mounted on the spigot (or protuberance) of a nose with a retainer system according to the present invention with the retainer pins (or bolts) in line for assembly;

FIG. 2 is a pictorial representation of the excavator bucket tooth, nose and retainer pins in FIG. 1 fully assembled with the retainer pins (or bolts) locked in the retaining position;

FIG. 3 is a pictorial representation of the assembly shown in FIG. 2 from a different view point;

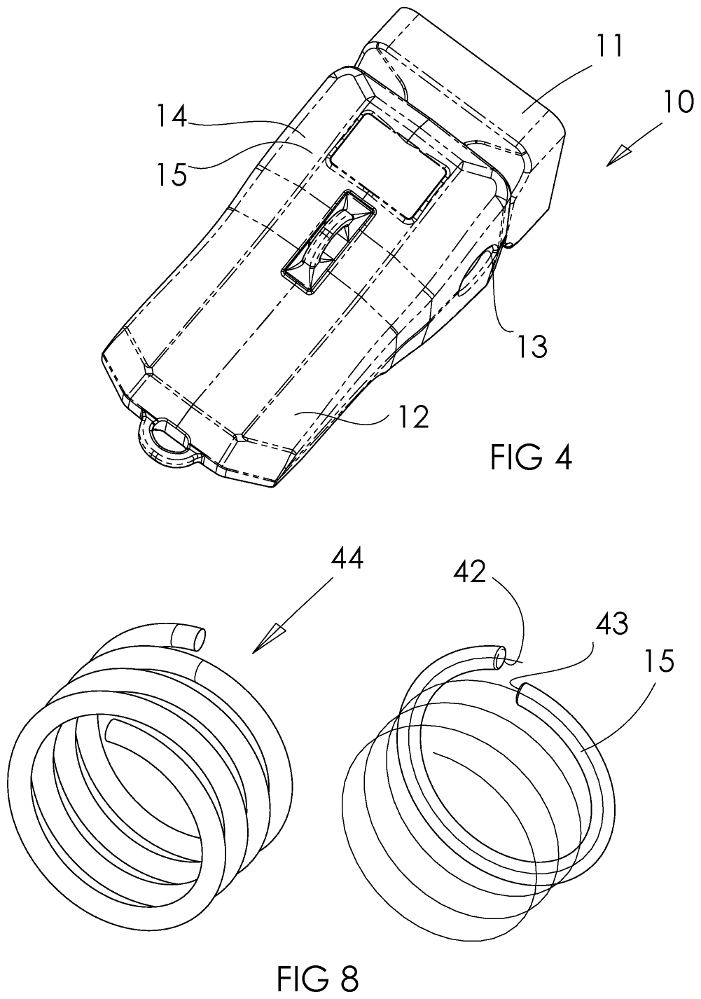

FIG. 4 is another pictorial representation of the assembly of FIG. 3 from another view point;

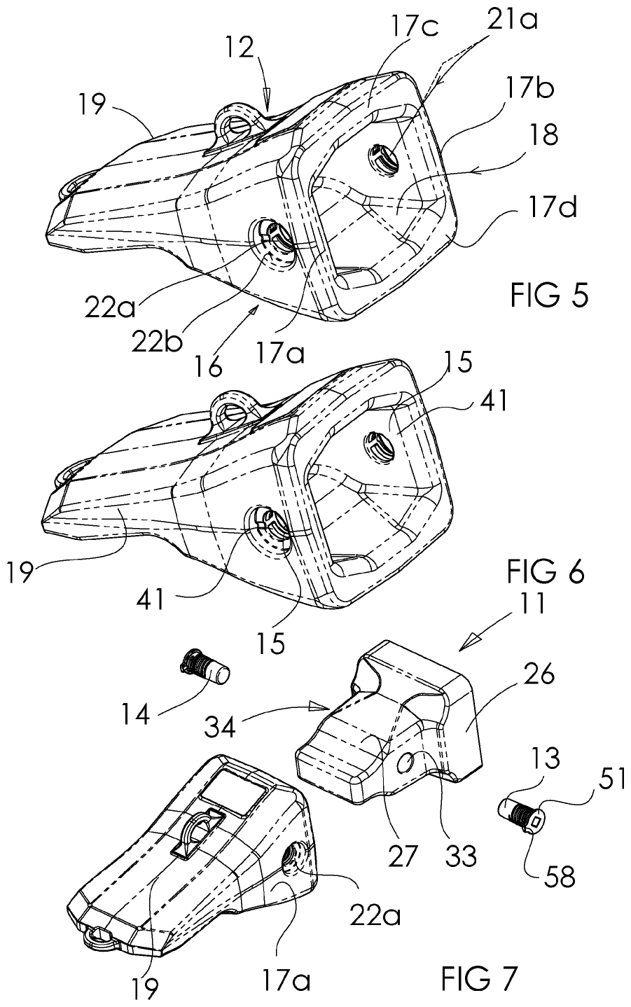

FIG. 5 is a pictorial representation of the tooth component of the assembly shown in FIG. 1 without the spiral coil fitted;

FIG. 6 is a pictorial representation of the tooth component as shown in FIG. 5 with the spring coil component fitted;

FIG. 7 is another pictorial representation of the assembly of FIG. 1 with the components in line for assembly;

FIG. 8 is a pictorial representation of a spiral coil piece cut from a coil spring to form the spiral coil component shown fitted to a tooth in FIG. 6;

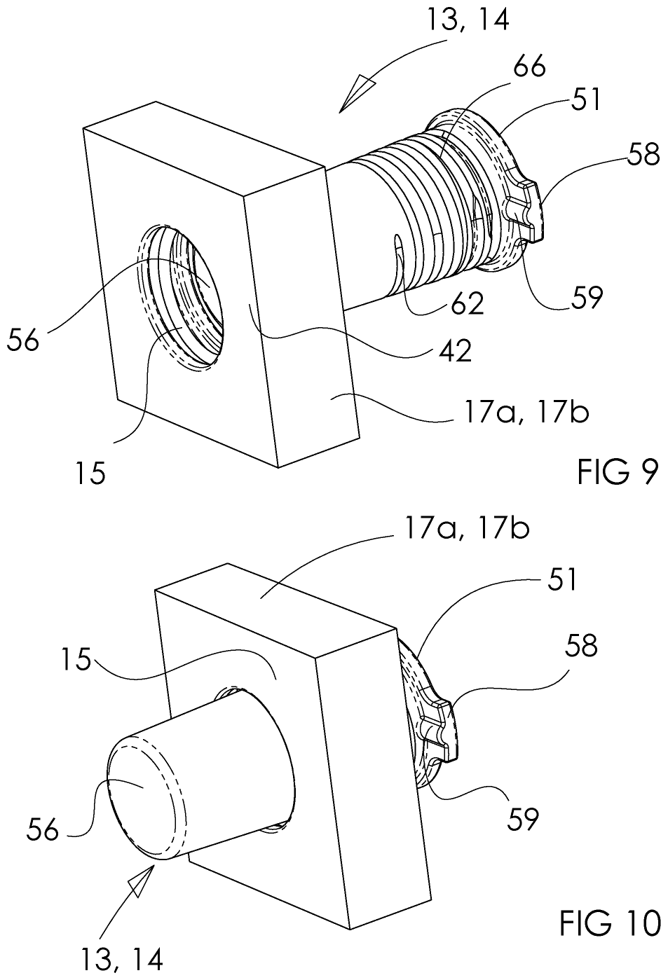

FIG. 9 is a pictorial representation of a portion of the side wall of the tooth shown in FIG. 6 with the locating pin partly extending into the side wall;

FIG. 10 is a pictorial representation of the same portion of the side wall of the tooth shown in FIG. 6 as in FIG. 9 with the locating pin extending partly through the side wall;

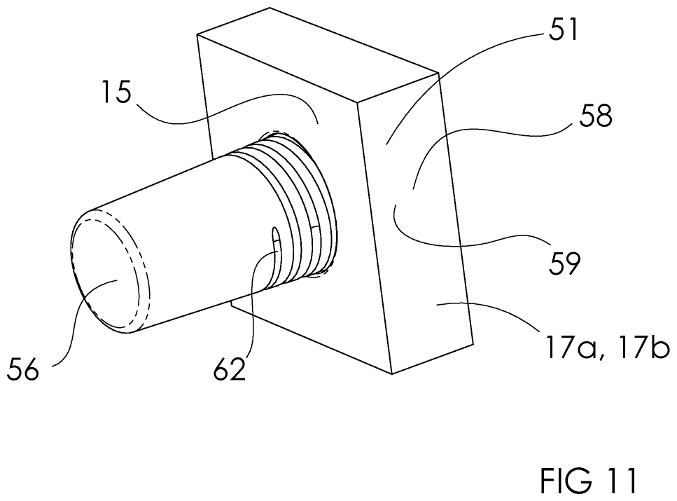

FIG. 11 is a pictorial representation of the same portion of the side wall of the tooth shown in FIG. 6 as in FIGS. 9 and 10 with the locating pin extending fully through the side wall;

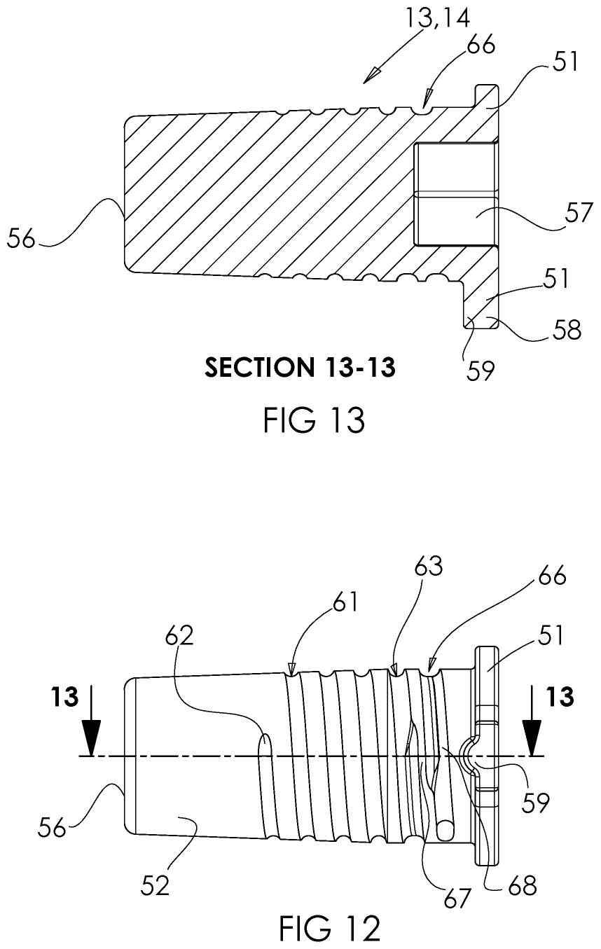

FIG. 12 is a side elevation of one of the locating pin components in the assembly of FIG. 1;

FIG. 13 is a sectional side elevation of the locating pin shown in FIG. 12 along line 13-13;

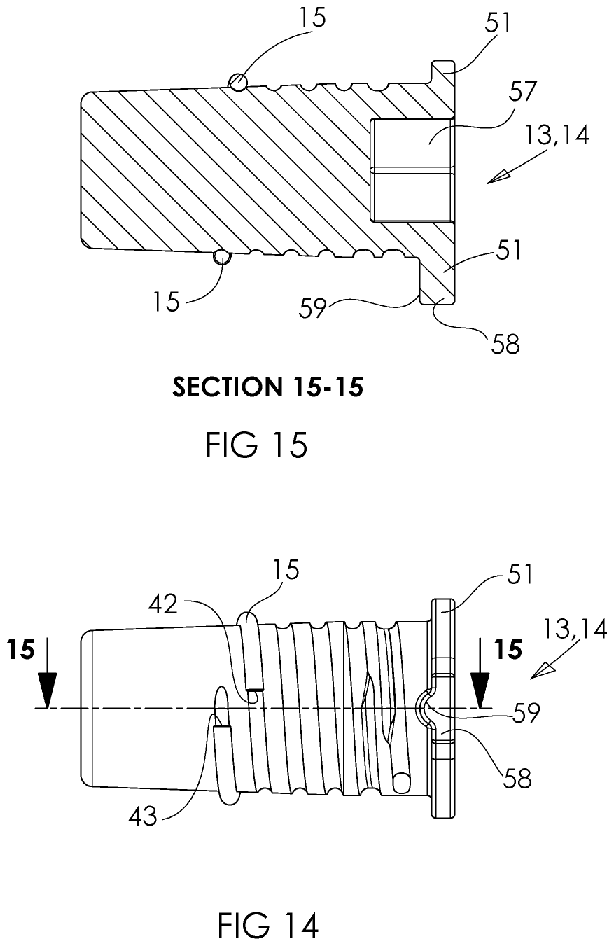

FIG. 14 is a side elevation of the locating pin shown in FIG. 12 partly engaged with the spiral coil in the tooth shown in the assembly of FIG. 1;

FIG. 15 is a sectional side elevation of the locating pin and spiral coil shown in FIG. 14 along line 15-15;

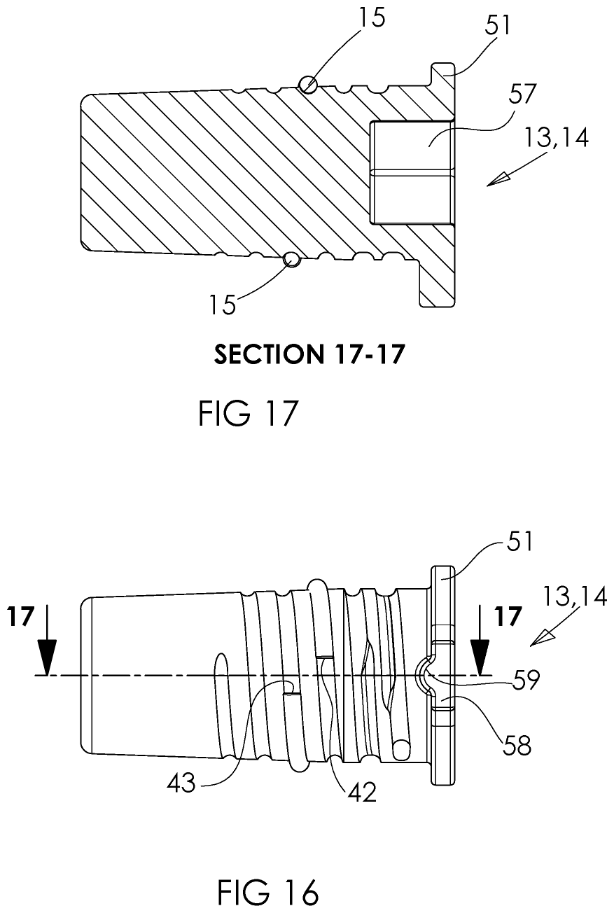

FIG. 16 is a side elevation of the locating pin shown in FIG. 12 approximately half engaged with the spiral coil in the tooth shown in the assembly of FIG. 1;

FIG. 17 is a sectional side elevation of the locating pin and spiral coil shown in FIG. 16 along line 17-17;

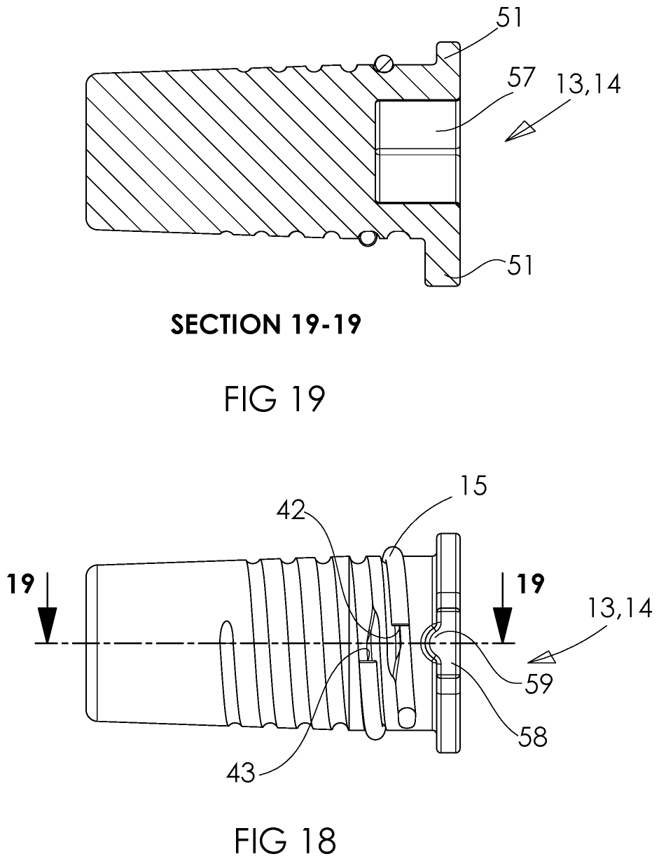

FIG. 18 is a side elevation of the locating pin shown in FIG. 12 fully engaged with the spiral coil in the tooth shown in the assembly of FIG. 1;

FIG. 19 is a sectional side elevation of the locating pin and spiral coil shown in FIG. 18 along line 19-19;

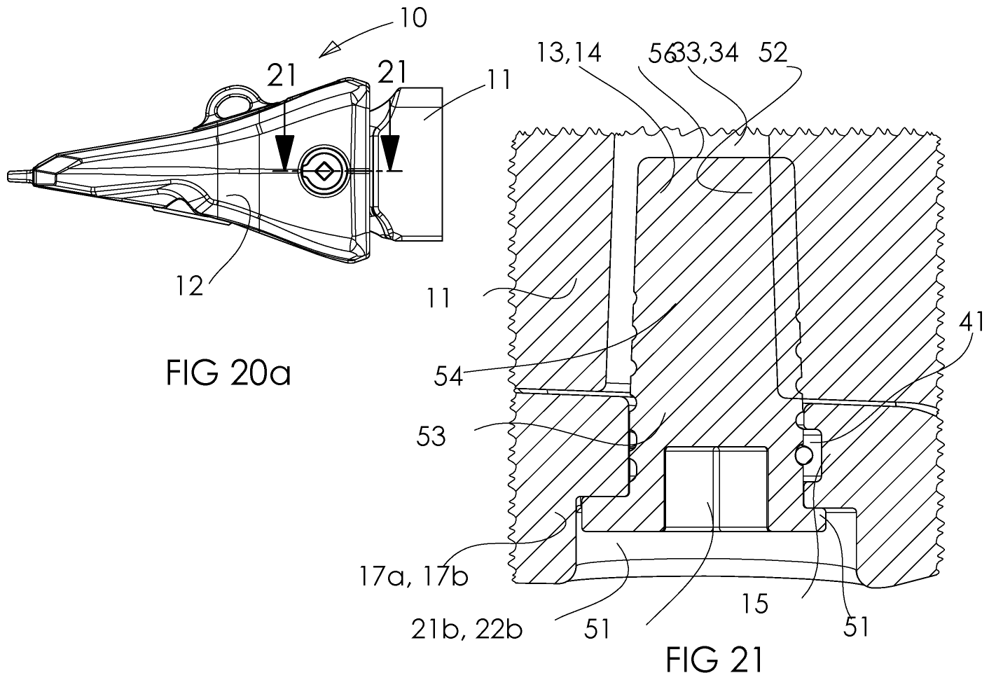

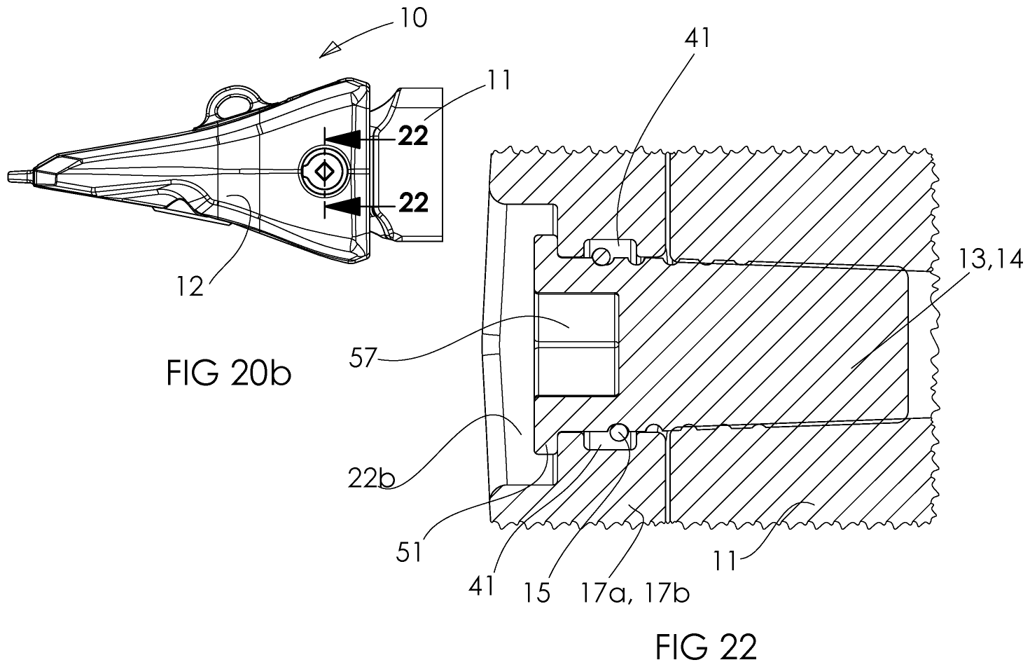

FIG. 20a is a side elevation of the assembly shown in FIG. 1 fully engaged with the spiral coil in the tooth shown in the assembly of FIG. 1;

FIG. 20b is another side elevation of the assembly shown in FIG. 1 fully engaged with the spiral coil in the tooth shown in the assembly of FIG. 1;

FIG. 21 is a partial sectional end elevation of the assembly shown in FIG. 20a along line 21-21;

FIG. 22 is a partial sectional side elevation of the assembly shown in FIG. 20b along line 22-22;

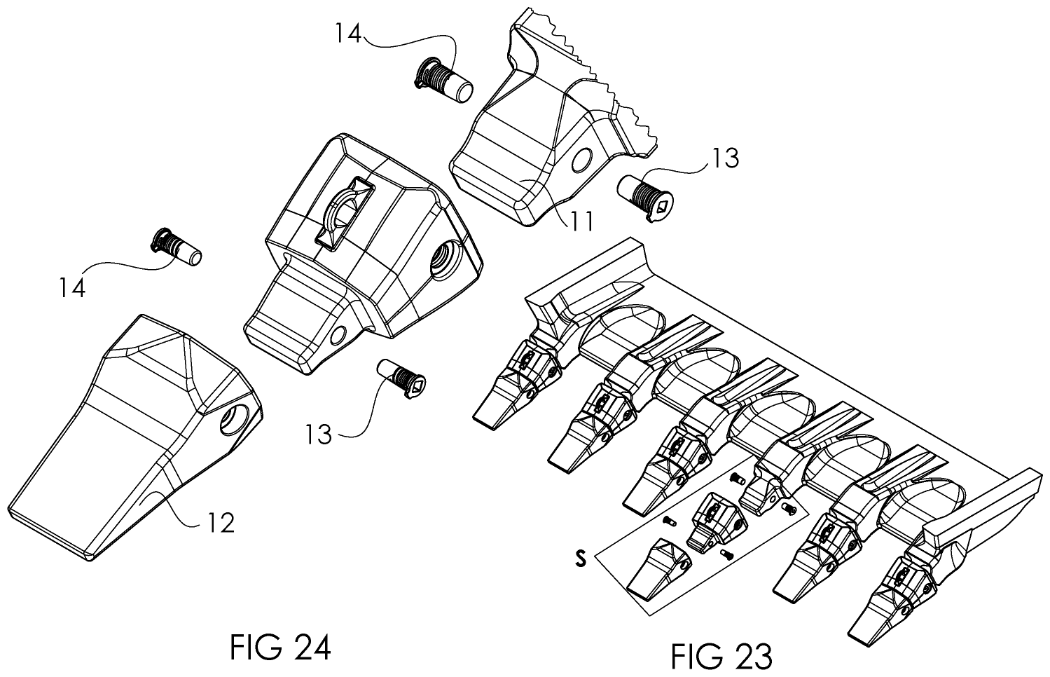

FIGS. 23 and 24 are pictorial representations showing the invention in use mounting an adaptor to a nose mount on a lip and a tooth to the adaptor;

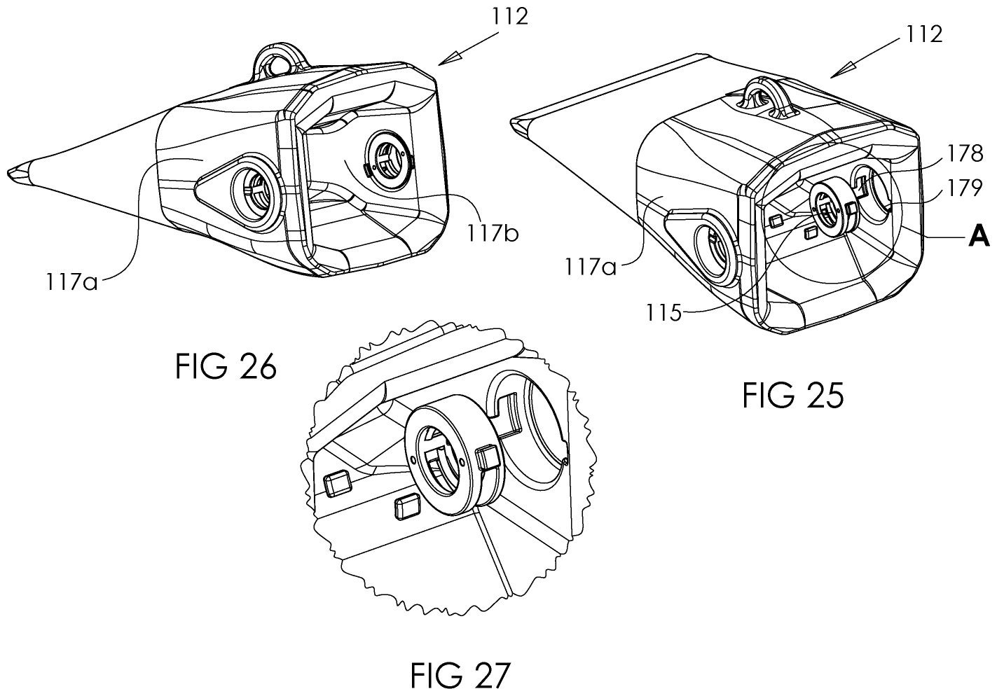

FIGS. 25 and 26 are pictorial representations showing a form of the invention in which the spiral coil is mounted in a housing and the housing with the spiral coil therein is in line for assembly with a tooth (or mounted in a tooth as in FIG. 26);

FIG. 27 is an enlarged portion of the spiral coil housing in line for assembly;

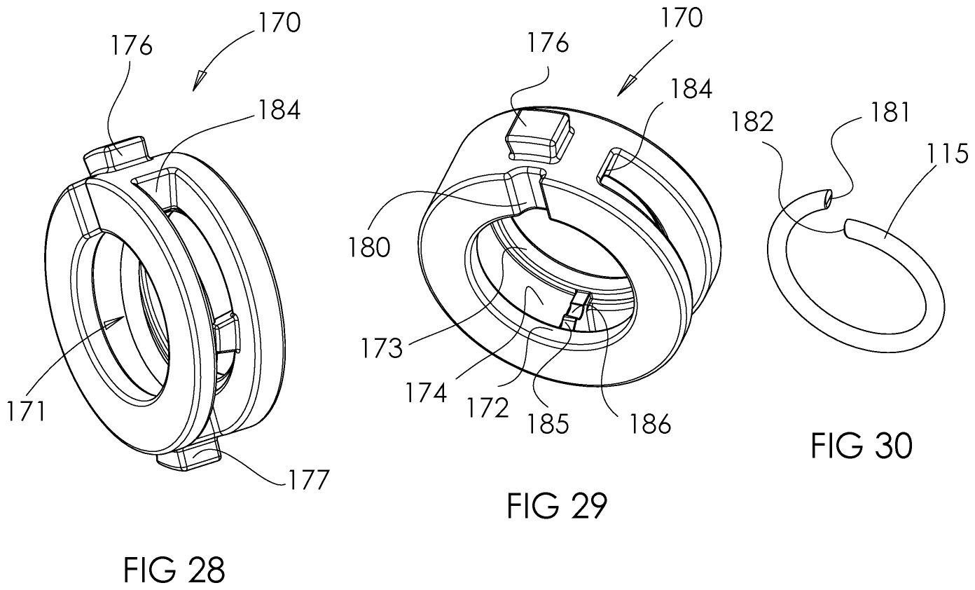

FIGS. 28 and 29 are pictorial representations of the coil housing containing a spiral coil shown in FIGS. 25 to 27;

FIG. 30 is a pictorial representation of the spiral spring in the assembly of FIGS. 25 and 26 ready to be fitted to the coil housing;

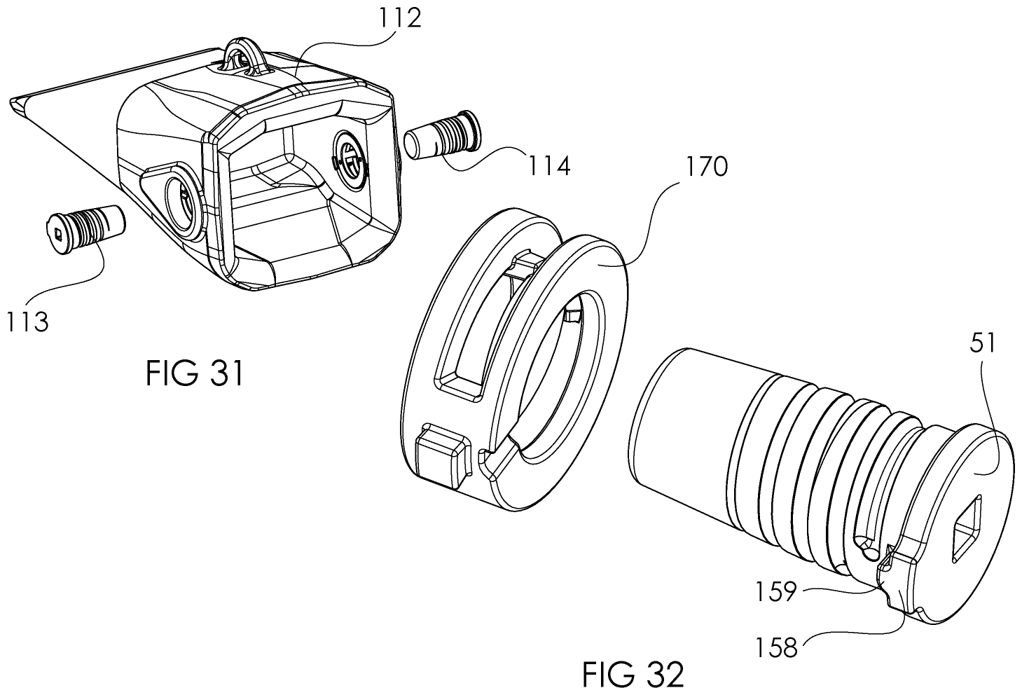

FIG. 31 is a pictorial representation of the spiral coil housing with coils fitted mounted in a tooth with the locking pins in line for assembly;

FIG. 32 is an enlarged pictorial representation of the locking pin and spiral coil housing in line for assembly but with the coil omitted for clarity;

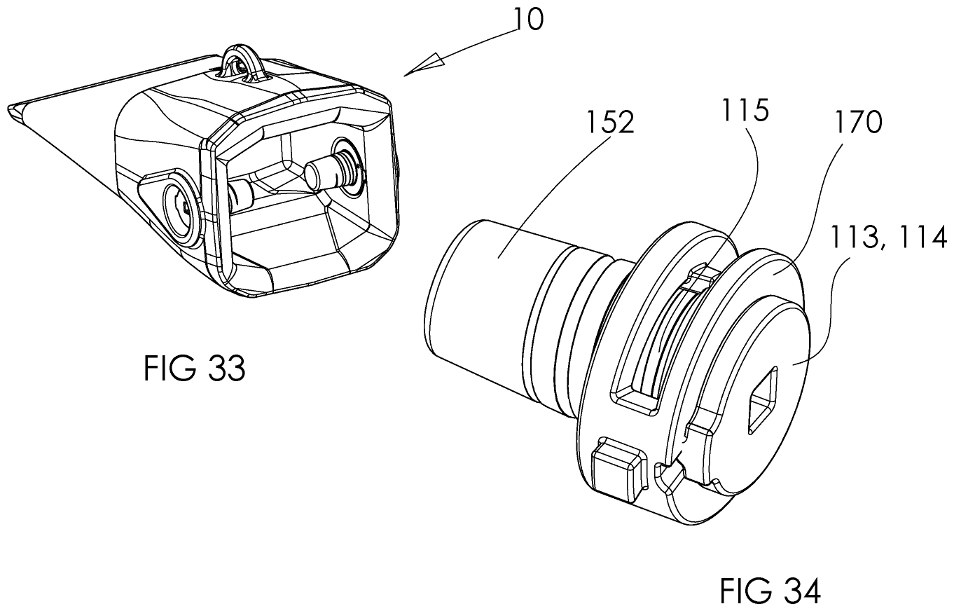

FIG. 33 is a pictorial representation of the tooth of FIG. 31 as it would appear mounted on a nose but with the nose omitted;

FIG. 34 is an enlarged pictorial representation of the locking pin and spiral coil housing with the coil fitted;

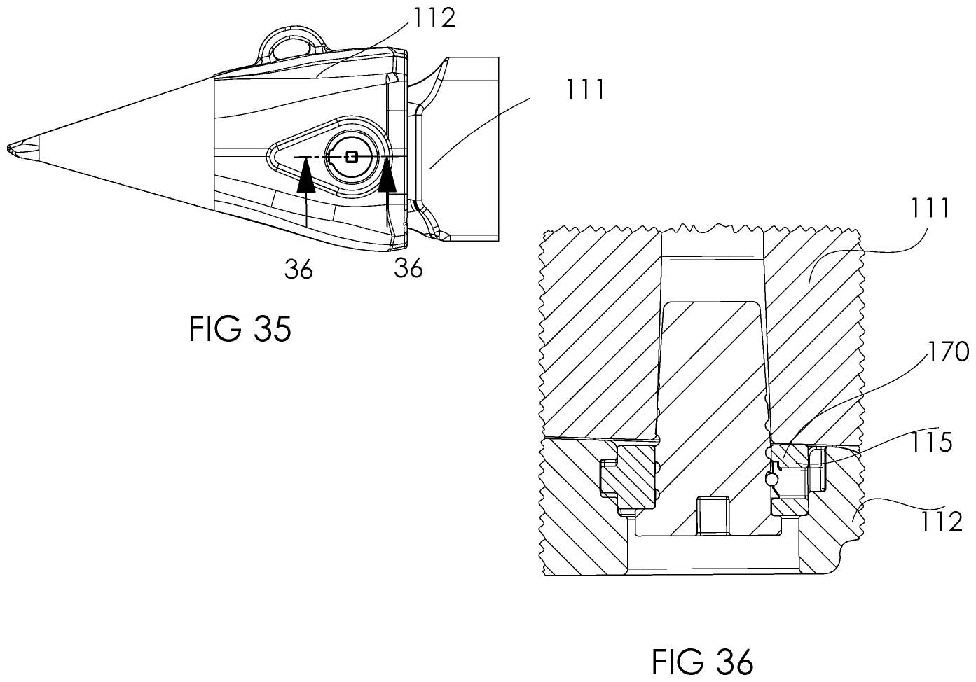

FIG. 35 is a side elevation of the tooth and nose of FIG. 33 with spiral coil housings with coils fitted;

FIG. 36 is a sectional plan in part of the tooth and nose of FIG. 35 along line 36-36;

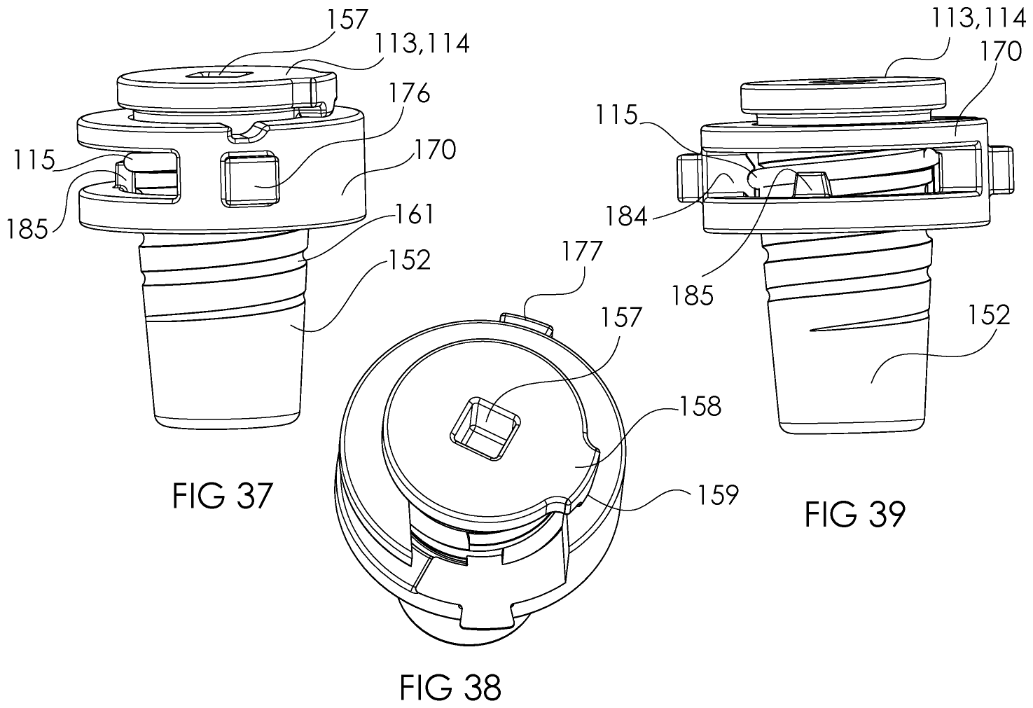

FIGS. 37 to 39 are pictorial representations of the spiral coil housing and pin in the almost fully engaged position with the tooth omitted for clarity;

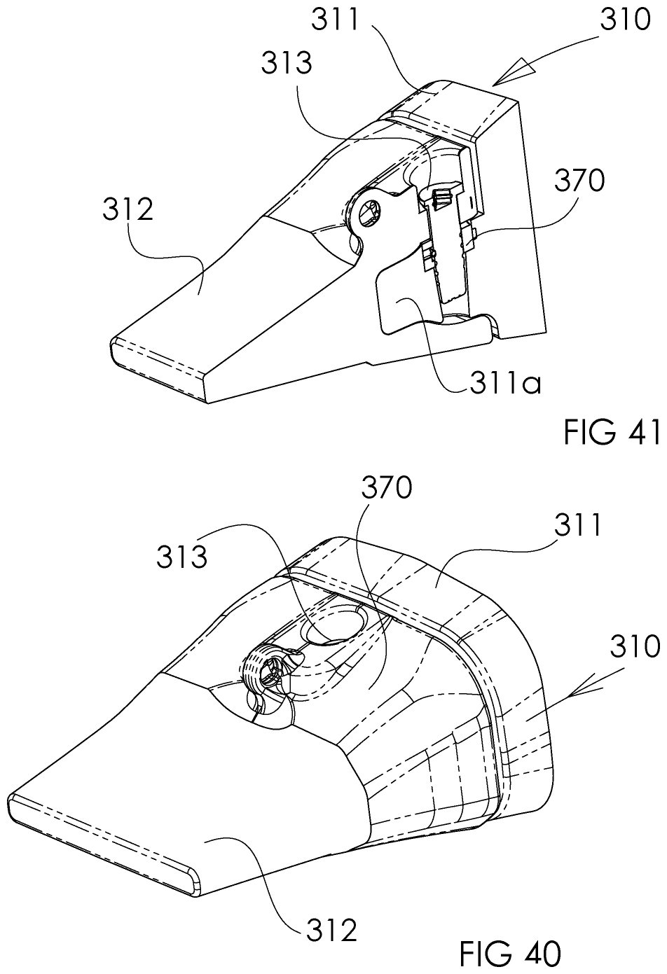

FIG. 40 is a pictorial representation of a protection system according to the invention with a single vertical retainer pin rather than two horizontal pins;

FIG. 41 is a sectional pictorial representation of the mount and tooth system of FIG. 40;

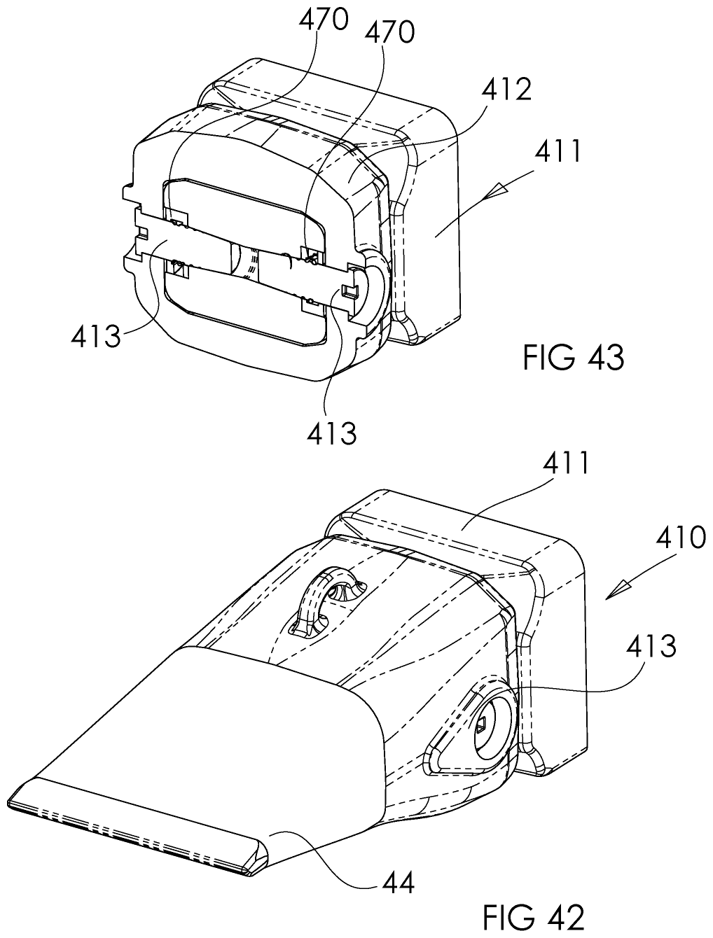

FIG. 42 is a pictorial representation of a mount according to the present invention with a tooth mounted thereto and secured by retainer systems according to the invention; and

FIG. 43 is a sectional pictorial representation of the mount and tooth of FIG. 42.

The assembly 10 illustrated in FIGS. 1 to 4 includes a nose mount 11, a tooth 12, retainer pins (or bolts) 13 on one side and 14 on the other side, and two spring coil inserts 15 fitted to the tooth on opposite sides as will be described in more detail later.

The tooth has a mounting portion 16 with a wall comprising two spaced apart side wall portions 17a and 17b joined by spaced apart upper and lower wall portions 17c and 17d which together define a rearwardly opening cavity 18 in the mounting portion and a cutting tip 19 extends forward from the mounting portion 16 as can be seen more clearly in FIG. 5. Aligned passages 21a and 22a extend through the side walls 17a and 17b respectively, the passages opening at their inner ends to the cavity 18 and at their outer ends opening into respective recesses 21b and 22b of larger diameter which are adapted to house the head of the respective retainers therein.

Nose mount 11 includes a base 26 which is adapted to be welded to the lip of an excavator bucket. The base is shown simply as a solid block because the shape of the base depends on the lip to which it is to be mounted and in realty the base is significantly longer. That aside, a nose-like protuberance 27 extends forward from the base and is configured to engage in the cavity 18 of the tooth 12 in generally known manner to mount the tooth on or to the nose mount. In that respect, typically a plurality of spaced apart nose mounts are welded to the lip and extend forward therefrom and teeth are fitted to the nose mounts and replaced from time to time as they wear out.

In the present case, the tooth 12 is retained on the nose mount 11 by the retainer pins 13 and 14 which extend through the aligned passages 21a and 22a in the side walls 17a and 17b of the tooth respectively and engage in blind holes or passages 33 and 34 respectively in the nose mount. In other forms of the invention, a single through passage is provided instead of the two blind holes 33 and 34.

In the assembly illustrated, the tooth is secured by two opposed retaining pins extending through the opposed side walls of the tooth and engaging the respective blind holes 33 and 34. However, in other embodiments the tooth is secured by only one pin engaging in only one hole in the nose mount. In some cases one pin may extend only through a top wall and in other cases pins may extend through top and bottom walls of the wear part. In other cases pins may extend through any other suitable wall or projection and in some cases several pins may be used to secure a wear part to a mother part.

As can be seen more clearly in FIG. 6, a recess 41 extends substantially (but not completely) about each side wall passage 21 and 22 leaving a bridge portion 42 and respective spring coils 15 are mounted in those recesses. The opposite ends 42 and 43 of the respective spring coils engage opposite sides of the respective bridge portion as can be seen in FIG. 20 allowing the bridge portion of the tooth to act as a stopper preventing rotation of the spring coils in their respective recesses.

It will be appreciated that the spring coil inserts 15 are taken from a spring 44 as seen in FIG. 8. In this case, the coil is slightly less than one full coil and extends through approximately 335 degrees of a full coil. The purpose in limiting the coil to less than a full circle is to allow the ends to remain in the recess 41 and abut the sides of the bridge portion previously mentioned. The spring 44 selected in this embodiment of the invention is a helical compression spring formed from 6 mm diameter wire having a spring rate of 14.8 N/mm and an unloaded pitch of 12 mm with an outside spring diameter of 66 mm.

The retainer pins 13 and 14 have a head 51 seated in recess 21b in the case of pin 13 and 22b in the case of pin 14 and a shank 52 extending from the head as can be seen more clearly in FIGS. 21 and 22. The shank extends through the relevant side wall 17a or 17b of the tooth and locates in blind hole 33 or 34 of the nose mount as the case may be.

It will be appreciated that the shank portion 53 of the pin within the side wall of the tooth (immediately adjacent the head) is cylindrical but the portion 54 beyond the tooth extending into the nose mount is tapered at about 2.0 degrees to the free end 56 and matches the taper of the recess or passages 33 and 34 of the nose mount which effectively would be frustoconical in geometric terms.

The head of each pin has a recess or cavity 57 therein adapted to receive a tool for unscrewing the pin when necessary. It also has a tang 58 extending radially outwards from the head and the tang includes a solid detent 59 extending axially towards the free end.

A spiral groove, 61 is provided in the shank 52 with the same pitch as the spiral spring coil 15. It will be appreciated that the commencement portion of the spiral groove at point 62 towards the free end 56 is relatively shallow while towards the other end the groove at point 63 is deeper approaching half the dimeter of the spring wire as a result of the taper of the pin.

Moreover, the groove commences at a predetermined distance from the free end of the pin. In that respect, the spring diameter and the pin diameter are selected such that the grove naturally commences at the predetermined position to allow the pin to enter the spiral spring coil component without interference from the coil when being fitted to the tooth.

It will also be seen that the final circle 66 of the groove (adjacent the head) is widened by superimposing a groove of smaller pitch on the standard circle thereby partly overlapping the standard circle between 67 and 68. Thus, in the present embodiment where the standard pitch of the spiral spring coil and the groove is 12 mm, the final circle of the groove is widened towards the free end 56 by superimposing a groove of 10 mm pitch on the groove of 12 mm pitch which effectively widens the root of the groove. In some embodiments the widened groove extends a full circle and in others it extends only over a portion of the final circle in the region of the detent 59.

It will be appreciated that the widened groove allows the spiral spring coil 15 in the tooth to compress (within its recess 41 towards the free end 56 of the pin within the final circle by the extent of the widening of the groove. Advantageously, when a tooth has to be replaced, unscrewing of the pin with a pneumatic impact driver or the like, allows the solid detent 59 to force the spiral spring coil to move away from the pin head as it turns and once the pin has rotated a small angle the detent will no longer be in contact with the coil and will turn freely.

Thus, the spiral spring coil together with the detent acts as a lock under the outward force of the compression spring and rotation of the locking pin overcomes that force by compressing the spiral spring coil towards the free end under the action of an impact driver. Once the detent is free of contact with the spiral spring coil, the pin will unscrew in the normal manner running with the groove sliding on the spiral coil as in the manner of a thread.

In use, a tooth is pushed onto a nose mount or the like to a position where the passages 21a and 22a of the tooth align with passages 33 and 34 respectively in the nose mount. The pins 13 and 14 are then pushed through the respective passages to a position where the tapered portion 54 of each pin engages in the respective passage in the nose mount and the head 51 of each pin abuts the shoulder face of the head recess. At that point the detent 59 should be engaged in the locking recess in the shoulder face and the spiral spring coil will be engaged in the final ring 66 of groove 61.

The tooth 112 illustrated in FIGS. 25 to 27 is the same in many respects to the tooth 12 illustrated in FIGS. 1 to 4 and where possible corresponding numbers will be used to reference corresponding features except prefaced by a “1”. The main difference between the two teeth is that in the tooth of FIGS. 1 to 4, the two spiral coils 15 are mounted directly in a recess provided in the opposite walls of the tooth while in the tooth of FIGS. 25 to 27 the two spiral coils 115 are mounted in respective housings 170 which in turn are mounted in the opposite side walls 117a and 117b as can be seen in FIGS. 25 to 27. In other applications a wear part may be secured to a mother part by only one pin and one coil while in others there might be several pins and coils.

The housing 170 is generally cylindrical in form and has a passage 171 extending therethrough from one side to the other and adapted to receive therethrough a locking pin 113 or 114 therethrough to engage in blind holes 133 or 134 in the nose mount in much the same manner as with the arrangement shown in FIGS. 1 to 4. The housing has two spaced apart side walls 172 and 173 which form a generally U-shaped channel or recess therebetween and a spiral coil 115 is mounted therein so as to form a helix with the opposite ends of the coil being spaced apart in the axial direction of the through passage so as to form a thread as can be seen in FIG. 30.

As can be seen in FIGS. 28 and 29, the housing has two outwardly extending lugs 176 and 177 which are adapted to engage in complementary recesses 178 and 179 provided in the walls of the tooth so as to secure the housings therein and to prevent relative rotation between the housings and the tooth walls. It will be appreciated that when the tooth is mounted on the nose, the outer faces of the nose will engage with the inner faces of the tooth and prevent inward movement of the housings.

The housings also have a recess 180 provided in the outer sidewall 172 which is adapted to receive therein detent 59 of locking pins 113,114 in the same manner as described earlier to prevent unwanted rotation of the locking pin when locked in the locking position.

The opposite ends 181 and 182 of the spiral coil engage respective circumferentially spaced radial faces 183 (not visible) and 184 to prevent rotation of the spiral coil relative to the housing and bridge portion 185 assists in holding the spiral coil in the desired position in which the spiral coil encroaches on the through passage 171 while in its helical attitude so as to engage with the locking pin when the locking pin is pushed into the locking position. That is to say, the spiral coil acts in the same manner relative to the locking pin as it does as it does in the arrangement illustrated in FIGS. 1 to 24.

Another arrangement is illustrated in FIGS. 40 and 41 where a single vertical retainer pin 313 is used to secure a tooth to a mount or to the protuberance of an adapter with the spiral coil mounted in a housing 370 which in turn is mounted in a recess provided in the spigot portion 311a of the mount or adapter 311. In an alternative system the spiral coil housing is mounted in the top wall of the tooth and the vertical pin 313 engages the coil in a similar manner. In that arrangement, the spiral coil is mounted in the tooth in the same manner as in the horizontal pin arrangement and the retainer pin is pushed in from above the tooth to engage in a passage in the nose mount.

Another arrangement is illustrated in FIGS. 42 and 43 where the spiral coil is mounted in a housing as described in relation to FIGS. 25 to 39 but in this case, the two spiral coil housings 470 are mounted in the nose portion of the mount 411. In that embodiment of the invention it will be appreciated that the retainer pin 413 is different to the extent that the spiral groove is closer to the free end of the pin and the portion of the pin adjacent the head of the pin is cylindrical for a greater length before the tapered portion starts.

While the foregoing description has been given by way of illustrative example of the invention, it will be understood that the invention may be embodied in many other forms and all such forms are deemed to fall within the broad scope and ambit of the invention as defined by the appended claims.

1. A wear protection system for earthmoving and mining equipment including:
a mount adapted to be secured to a part of the equipment to be protected,
a wear part adapted to be releasably mounted on or to said mount; and
a retainer adapted to retain or secure said wear part on or to said mount;
wherein said mount includes a passage or recess therein; and
wherein said wear part includes a wall portion having a passage therethrough, said passage being positioned to generally align with said passage or recess in said mount and wherein a spiral coil is mounted in said wear part to form a thread extending substantially around said passage or in said mount to form a thread extending substantially around said passage or recess therein; and
wherein said retainer includes a pin or bolt, said pin or bolt having a free end and at least a portion tapering inwards towards said free end, and a spiral groove or thread on or in at least a portion of said pin or bolt;
said parts being so made and arranged that said pin or bolt can be pushed into said passage in said wear part to engage with said passage or recess in said mount so as to secure said wear part to said mount and be retained by engagement of said spiral coil with said spiral groove or thread.

2. A wear protection system according to claim 1, wherein said parts are so made and arranged that said pin or bolt can be rotated to screw and/or unscrew along said spiral groove or thread to disengage said pin or bolt from said mount to release said wear part from said mount.

3. A wear protection system according to claim 1, wherein said spiral coil is mounted in said wall portion of the wear part and extends less than one full turn about the passage therethrough.

4. A wear protection system according to claim 3, wherein the wall portion of the wear part includes a stopper portion extending into the passage and configured to prevent the coil from rotating relative thereto.

5. A wear protection system according to claim 1, wherein the mount includes a nose portion and said spiral coil is mounted in said nose portion and extends less than one full turn about the passage or recess therein.

6. A wear protection system according to claim 5, wherein the nose portion of the mount includes a stopper portion extending into the passage or recess and configured to prevent the coil from rotating relative thereto.

7. A wear protection system according to claim 6, wherein the opposite ends of the spiral coil are arranged to abut the stopper portion.

8. A wear protection system according to claim 1, wherein said spiral coil is a coil of a compression spring.

9. A wear protection system according to claim 8, wherein the spring wire diameter and type is selected to suit the size and loading of the wear part and the diameter of the pin or bolt.

10. A wear protection system according to claim 1, wherein the pin or bolt has a head and the passage through the wall portion of said wear part opens outwardly to a recess adapted to accommodate the head of the pin or bolt therein.

11. A wear protection system according to claim 10, wherein the recess terminates in a shoulder face adjacent the passage against which the head of the bolt or pin may rest and wherein said shoulder has a recess therein in which a detent may engage.

12. A wear protection system according to claim 1, wherein the spiral coil is mounted in a housing which in turn is mounted in the recess or passage through the wall portion of the wear part or the passage or recess in the mount.

13. A wear protection system according to claim 12, wherein the recess or passage through the wall portion of the wear part has a larger inner portion adapted to receive therein the housing in which the spiral coil is mounted and wherein the mount has an outer face adapted to engage with the spiral coil housing to secure the housing in the wall portion of the wear part.

14. A wear protection system according to claim 12, wherein the recess or passage in the mount has a larger outer portion adapted to receive therein the housing in which the spiral coil is mounted and wherein the wear part has an inner face adapted to engage with the spiral coil housing to secure the housing in the mount.

15. A wear protection system according to claim 1, wherein the pin or bolt includes a head and a shank extending from said head to said free end, and wherein a tapered portion is on said shank and said spiral groove or thread is on or in at least a portion of said shank.

16. A wear protection system according to claim 15, wherein said shank includes an outer portion intended to locate in a wall portion of the wear part and substantially that portion is not tapered.

17. A wear protection system according to claim 16, wherein the tapered portion of the shank extends from the outer portion of the shank to the free end.

18. A wear protection system according to claim 15, wherein the included angle of the tapered portion of the shank is in the range of 3.0 degrees to 11.0 degrees (that is 1.5 and 5.5 degrees when seen in section between the outer face and the longitudinal axis of the tapered portion).

19. (canceled)

20. A wear protection system according to claim 18, wherein the included angle of the tapered portion of the shank is about 4.0 degrees.

21. (canceled)

22. A wear protection system according to claim 1, wherein the pin or bolt includes a head and a shank extending from the head and wherein said head includes a protuberance such as a detent, tang or the like extending axially from the head and adapted to engage with complementary locating means in the wear part.

23. (canceled)

24. A wear protection system according to claim 1, wherein said spiral coil is mounted in a housing which is mounted in said wear part to form a thread extending substantially around said passage or in said mount to form a thread extending substantially around said passage or recess therein.

25-31. (canceled)

32. A retainer pin or bolt for use with a wear protection system for earthmoving and mining equipment, the retainer pin or bolt including:
a head and a shank extending from said head, said shank tapering inwards away from said head over at least a portion of said shank, and
a spiral groove or thread on or in at least a portion of said shank and wherein at least two turns of said spiral groove or thread are on said tapered portion of said shank.

33-40. (canceled)

41. A wear protection system for earthmoving and mining equipment including:
a first component, a second component, and a third component, wherein the third component is a helical coil adapted to be fitted to a passage or recess provided in one of said first and second components to form a thread extending substantially around said passage or recess and wherein said one component includes means for preventing or at least inhibiting unwanted rotation of said third component relative thereto.

42-44. (canceled)

45. A nose mount, tooth and retainer in combination for earthmoving or mining equipment;
the nose mount having a base for securing the nose mount to the lip of a bucket and a protuberance extending forwardly therefrom with one or more recesses or passages provided therein;
the tooth having a cutting tip at its front and a mounting portion rearward of the cutting tip, the mounting portion including one or more walls defining a cavity therein opening to the rear and adapted to at least partially receive therein the protuberance of the nose mount, a passage through at least one of said one or more walls, said passage being positioned to generally align with one of said one or more recesses or passages in said protuberance and a spiral coil mounted in said passage to form a thread extending substantially around said passage;
the retainer including a pin or bolt, said pin or bolt having a head portion and a shank extending away from said head portion, said shank tapering inwards away from said head portion over at least a portion of said shank and terminating in a free end, and a spiral groove or thread on or in at least a portion of said shank;
the parts being so made and arranged that the shank of said pin or bolt can be pushed into said passage in said wall to engage with said passage or recess in said nose mount to secure said wear part to said mount and be retained by engagement of said spiral coil with said spiral groove or thread.

46. An adaptor, nose mount and retainer in combination for earthmoving or mining equipment;
the nose mount having a base for securing the nose mount to the lip of a bucket and a protuberance extending forwardly therefrom with one or more recesses or passages provided therein;
the adaptor having a mounting portion including one or more walls defining a cavity therein opening to the rear and adapted to at least partially receive therein the protuberance of the nose mount, and a passage through at least one of said one or more walls, said passage being positioned to generally align with one of said one or more recesses or passages in said protuberance of said nose mount and a spiral coil mounted in said passage to form a thread extending substantially around said passage, the adaptor also having a protuberance extending forwardly from said mounting portion and adapted to receive thereon a tooth;
the retainer including a pin or bolt, said pin or bolt having a head and a shank extending from said head, said shank tapering inwards away from said head over at least a portion of said shank and terminating in a free end, and a spiral groove or thread on or in at least a portion of said shank;
wherein said parts are so made and arranged that the shank of said pin or bolt can be pushed into said passage in said wall of said adaptor to engage with said passage or recess in said nose mount to secure said adaptor to said mount and be retained by engagement of said spiral coil with said spiral groove or thread.

47. (canceled)

48. An adaptor, tooth and retainer in combination for earthmoving or mining equipment;
the adaptor having a mounting portion including one or more walls defining a cavity therein opening to the rear and adapted to at least partially receive therein the protuberance of a nose mount, and a protuberance extending forwardly therefrom with one or more recesses or passages provided therein;
the tooth having a cutting tip at its front and a mounting portion rearward of the cutting tip, the mounting portion including one or more walls defining a cavity therein opening to the rear and adapted to at least partially receive therein the protuberance of the adaptor, a passage through at least one of said one or more walls, said passage being positioned to generally align with one of said one or more recesses or passages in said protuberance of said adaptor and a spiral coil mounted in said passage to form a thread extending substantially around said passage;
the retainer including a pin or bolt, said pin or bolt having a head portion and a shank extending from said head portion, said shank tapering inwards away from said head portion over at least a portion of said shank and terminating in a free end, and a spiral groove or thread on or in at least a portion of said shank;
the parts being so made and arranged that the shank of said pin or bolt can be pushed into said passage in said wall of said tooth to engage with said passage or recess in said protuberance to secure said wear part to said adaptor and be retained by engagement of said spiral coil with said spiral groove or thread.

49. (canceled)

50. A wear part for use with a wear protection system for earthmoving and mining equipment, the wear part including:
a wall portion having a passage therethrough adapted to receive a pin or bolt therein, and a recess extending substantially about the passage, the recess being adapted to hold therein a part coil of an extension spring adapted to form a thread about the passage and stop means at the ends of the recess or in the recess adapted to engage the opposite ends or end portions of a coil in the recess.

51-66. (canceled)
